(19) United States
(12) Patent Application Publication
(10) Pub. No.: US 2023/0213918 A1
(43) Pub. Date: Jul. 6, 2023

(54) Method and System for Determining a Compression Rate for an AI Model of an Industrial Task

(71) Applicant: Siemens Aktiengesellschaft, Muenchen (DE)

(72) Inventors: Vladimir LAVRIK, Dreieich, Hessen (RU); Yang Qiao MENG, Beijing, (CN)

(21) Appl. No.: 18/016,881

(22) PCT Filed: Jul. 6, 2021
(86) PCT No.: PCT/EP2021/068651

§ 371 Date: Jan. 19, 2023

(30) Foreign Application Priority Data
Jul. 21, 2020 (EP) 20186916.1

(51) Int. Cl. G05B 19/418

(52) U.S. Cl. CPC G05B 19/4183; G05B 19/4185; G05B 2219/35588

(57) ABSTRACT

A recommendation system and method for determining a compression rate for an AI model of an industrial task, wherein the parameters are reduced to a reduced number of parameters for the AI model, where each AI model is compressed with different compression rates in a first stage, where each compressed AI model is executed and the runtime properties are recorded as first results during the executions and an optimal compression rate is calculated by analyzing the first results and stored in a database, wherein data from the database is used to train an additional machine learning model in a second stage and, in a third stage, for a new AI model of a new task, a new set of desired runtime properties is defined and the additional model is employed for determining the optimal compression rate for that new AI model with respect to the desired runtime properties.

### CROSS-REFERENCE TO RELATED APPLICATIONS

This is a U.S. national stage of application No. PCT/EP2021/068651 filed 06 Jul. 2021. Priority is claimed on European Application No. 20186916.1 filed 21 Jul. 2020, the content of which is incorporated herein by reference in its entirety.

### BACKGROUND OF THE INVENTION

### 1. Field of the Invention

The invention relates to a system, a computer program product and a method for determining a compression rate for an AI model of an industrial task.

### 2. Description of the Related Art

The conception of industrial internet of things together with revolutionary analytical techniques based on AI can be described by the following sentences: Given a production site, a customer or an automation manufacturer installs industrial equipment with a possibility to collect the different kind of data with a usage of different sensors. Collected data are transmitted via either wired or wireless connections for further analysis. The analysis of the data is performed using either classical approaches or AI methods. The data analysis can be conducted either on the Cloud or onsite with a deployed model (AI model) on “edge devices” or on other computing devices. Based on the results of data analysis, the customer or the automation manufacturer itself can perform optimization of business/production processes to decrease the cost of a production, electricity consumption, resources usage and as a result to decrease an overall contribution to a global climate change.

AI models are executed on industrial edge devices, industrial controllers (e.g., programmable logic controllers (PLC)) or even on cloud-based computing entities, “web services” or “cloud hosting”.

The challenge is, that the more accurate an AI model works, the more resources (memory space, and/or computation time) it requires. On the other hand, in existing environments computation power (“CPU time”) is limited. Moreover, in most cases the response of an AI model is due within a limited timeframe, so the maximum response time or “inference time” is limited. AI models can be compressed, e.g., in reducing their parameters, to speed up and reduce memory allocation or other resource consumption. However, this compression reduces the accuracy of the prediction provided by an AI model.

CN 110 163 341 A “Neural network model optimization processing method and device” discloses a compression method for a deep neural network.

One approach how to perform optimizations as indicated above, together with a proper AI model, is to find a way how to optimize this AI model in order to deploy it on the edge device or another execution environment like an industrial controller, so that it will be run as accurately and efficiently as possible, with the aim to decrease a computational effort and to decrease an overall power consumption.

### SUMMARY OF THE INVENTION

Accordingly, it is an object of the invention to provide a method and a recommendation system for choosing an optimal compression rate of an AI model that shall be deployed in an industrial environment.

The solution of this task considers the industrial environment requirements, hardware resources of the edge device (or other execution environment) itself and the requirements specified to AI model in the analytical project (“industrial task”) description.

When selecting a compression rate for AI model, there is a tradeoff in that a higher compression rate would save more memory space and improve the prediction speed, but a larger decrease of AI model accuracy occurs. Similarly, a lower compression rate would have the opposite effect. The core of this invention reside in applying mathematical methodology from the area of operation research to tackle this tradeoff. In doing so, a compression rate is provided, which maximizes the AI model prediction accuracy while satisfying both the limit of space memory and the requirement of predicting speed (inference time). It should be understood other criteria or “features” such as deployment time, can also be a part of the optimization problem.

These and other objects and advantages are therefore achieved in accordance with the invention by a method for determining a compression rate for an AI model of an industrial task according to a set of requirements for the runtime properties of the AI model, where, for the AI model, the original number of parameters is reduced to a reduced number of parameters. In a first stage of the method, for a number of different AI models for a number of industrial tasks for each of the industrial tasks, a number of different compression rates for the assigned AI model is determined. After that, in a first step each AI model is compressed multiple times with that number of different compression rates. In a second step, each of the compressed AI models is executed in an execution environment, whereby as first results during the execution of each of the AI models the runtime properties are recorded, and where in a third step an optimal compression rate for each of the AI models is calculated by an analytical analysis of the first results, whereby the optimal compression rate for each industrial task together with a description of the industrial task is stored in a database or similar storage technology. In a second stage of the method, the data from the database is used to train an additional machine learning model, where the additional machine learning model has feature information about each of the industrial tasks as an input and the calculated optimal compression rate as the output, and the feature information at least comprises information of memory allocation limit, inference time limit for the compressed model, an original AI model size of the uncompressed AI model, and used compression algorithm. In a third stage, for a new AI model of a new industrial task, a new set of desired runtime properties is defined and the additional machine learning model is executed and employed for determining the optimal compression rate for that new AI model in respect to the desired runtime properties. The new AI model is then compressed according to the determined optimal compression rate and executed for fulfilling the new industrial task. Using this method, the AI model runs with the best possible accuracy while meeting the requirements of inference time and not exceeding allowed or given computing resources and requirements.

It is also an object of the invention to provide a system for determining a compression rate for an AI model of an industrial task according to a set of requirements for the runtime properties of the AI model, where, for the AI model, the original number of parameters is reduced to a reduced number of parameters. The system comprises a first computer system configured to conduct the steps of the first stage of the above-described method and for controlling the execution environment while execution of the compressed AI models occurs. The system further comprises a second computer system configured to perform the above-described method steps of the second and third stage, and a communication channel connecting the first and the second computer system. This system can achieve the advantages as described in connection with the inventive method.

In one embodiment, a compressed AI model is created and executed for every compression rate in the first step. The various compression rates might cover a wide range of compression, but are distinct in small steps so as to have an accurate basis for the analytical analysis in the third step.

In most cases, it might be appropriate to use at least memory consumption and inference time of the executed AI model as runtime properties. The requirement of maximum inference time is, in most cases, given by a use case of the industrial task, and the memory consumption is, in most cases, just dependent on the given execution environment (computing device). Accordingly, for a system engineer it will be easy to provide these properties parameters.

In one particularly important embodiment, in the third step the optimal compression rate is the compression rate with the best inference accuracy that still fits the requirements for the runtime properties. As a result, a system in which given computing capacities are employed to a maximum is obtained.

In the third step, for each AI task linear or non-linear, functions are fitted through the recorded runtime properties. This aspect can be achieved using conventional software and does not require user input. The linear or non-linear functions might comprise interpolation, e.g., linear interpolation or spline interpolation, but is not limited by these.

In the second and third stage, the feature information for each of the industrial tasks at least comprises: information of memory allocation limit, inference time limit for the compressed model, an original AI model size of the uncompressed AI model, and type of the compression algorithm used for that specific task.

It is advantageous to use an industrial edge device for execution of the AI model because edge devices provide computational power to industrial shop floors and thus unburdens the controllers (programmable logic controllers (PLC)) from time consuming computations, i.e., running the AI model. In other cases, it can be a different device at hand, in particular a neural processing unit (a so-called technology module for neural processing) which might be part of an industrial controller.

In one embodiment, the executions of the AI task in stage one can be implemented at different platforms (execution environments), returning the optimal compression rate for each of these environments. In other cases, for reducing the number of “test”-executions in stage one, it is possible to use empiric resource employment factors. That means, that once the runtime properties on a first type of platform have been determined, the runtime properties of the same AI task with the same compression rate but on a different platform (execution environment) can be estimated via an empiric factor.

In another advantageous embodiment, an emulation device for conduction the test series of stage one is used. That means, for example, that a PLC or a neural processing unit or another type of execution environment can be simulated (“emulated”) with a standard hardware, e.g., a personal computer or a virtual machine.

In some embodiments, the “target” in stage one is a cloud computing service (CCS). Cloud computing services can deliver virtual unlimited computing resources, particularly in cases in which a limited number of parameters need to be exchanged between a local entity (such as a PLC) and the cloud computing service, where the latter executes the AI model.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing shows an exemplary embodiment of the invention, in which:

FIG. 1 is a schematic block diagram of the method in accordance with the invention;

FIG. 2 is a schematic block diagram of an algorithm utilized at stage 1 of the method of the invention;

FIG. 3 is a database (table) generated during the execution of stage 1 of the method in accordance with the invention; and

FIG. 4 is a schematic block diagram of a system in accordance with the invention.

### DETAILED DESCRIPTION OF THE EXEMPLARY EMBODIMENTS

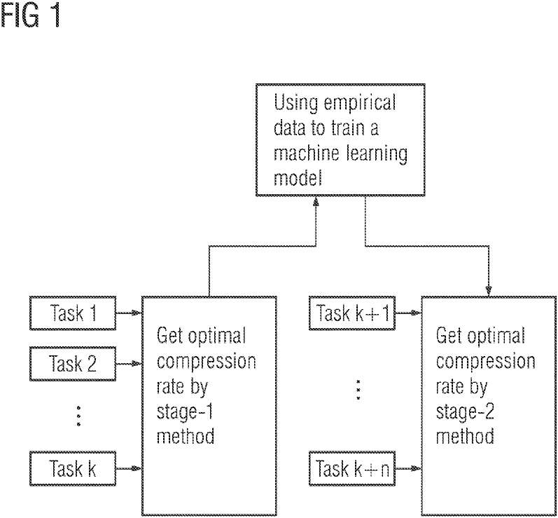

FIG. 1 shows a schematic view of the method in accordance with the invention. The method consists of three stages. Stage 1 seeks to run an algorithm shown on the left-hand side of FIG. 1 and obtain an optimal compression rate r* for every AI task (Task 1, 2, ... k). At stage 2 (shown in the middle) having information on AI tasks and their optimal compression rate r*, a machine learning model is trained to generalize over tasks and their corresponding optimal compression rates r* (upper box in the picture). Having a trained machine learning model, in the third stage (shown on the right-hand side) for every new AI task (Task k+1, k+2, ... k+n) an optimal compression rate r* is output without running an algorithm of stage 1 for the new AI tasks (Task k+1, k+2, ... k+n) .

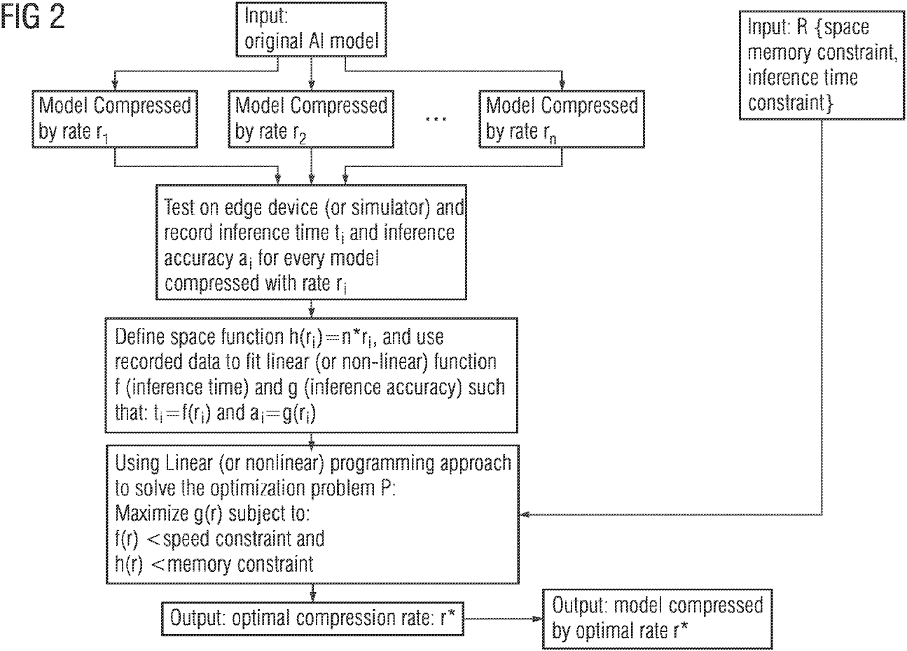

FIG. 2 shows a schematic view on an algorithm used at stage 1 of the method in accordance with the invention. Having as input an original AI model and AI task runtime requirements R (“constraints”), an optimization problem is formulated with the aim aiming of maximizing an accuracy of a compressed AI model with respect to AI task constraints and to output an optimal compression rate r* of the AI model.

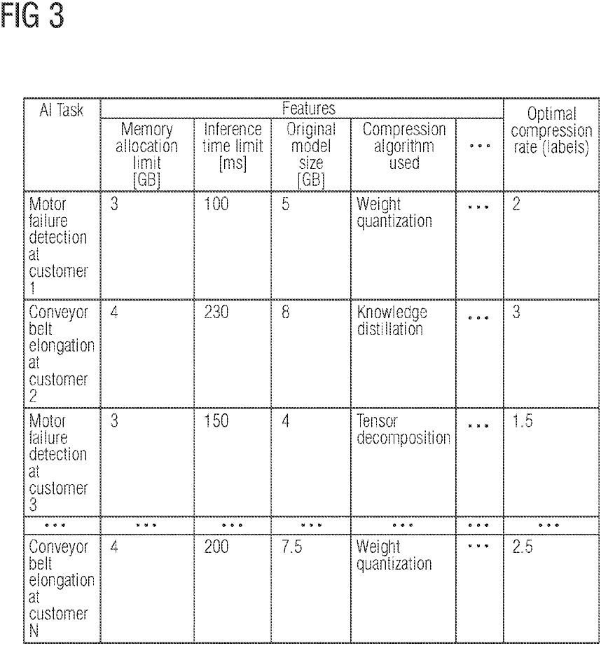

FIG. 3 shows a database (table) generated during the execution of stage 1 of the inventive method. Having information on AI tasks and their compression rates r* as output from stage 1, a machine learning problem is formulated where every AI task with its constraints is associated with its compression rate r* in order to train any suitable machine learning model. It should be understood it is possible to use a trained machine learning model to obtain an optimal compression rate r* without again running an algorithm of stage 1 as shown in FIG. 2 every time for a new, but similar AI task. The columns with the headline “Features” show some of the requirements R that have been met in the execution of the AI model for the various AI tasks. Such requirements (Features) can be, together with the description of a new AI task, serve as an input when asking the trained machine learning model about the optimal compression rate r* for an AI model of that new AI task. It should be particularly noted that, for the sake of conciseness, the table of FIG. 3 is limited to a small number of parameters (features, requirements); actual systems might employ more different requirements, parameters, and/or AI tasks.

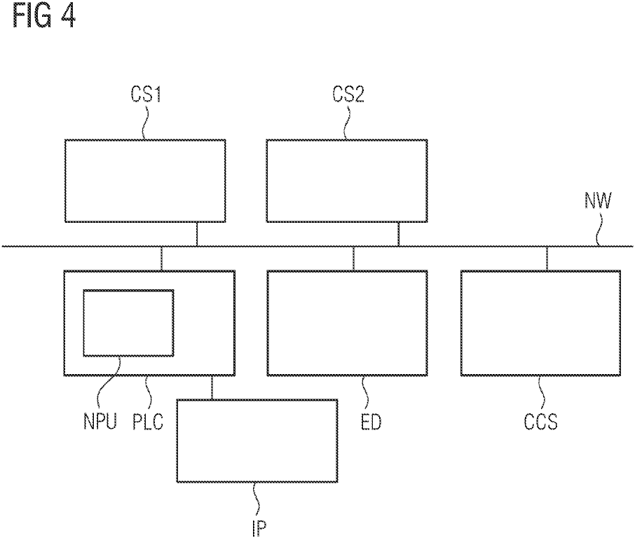

FIG. 4 shows a schematic of a system for executing the method in accordance with the invention. The system comprises various execution environments such as a cloud computing service CCS, an industrial edge device ED, or a Neural Processing Unit NPU of a programmable logic controller PLC. The various execution environments are connected, via a communication channel (the network NW), to computer systems CS1, CS2 that respectively run stage 1 and stages 2 and 3 of the inventive method. In an embodiment, all stages can be realized by the same computer system CS1 or CS2, but might be realized with different software modules. The programmable logic controller PLC is connected, e.g., via a fieldbus system, to an industrial process IP that comprises an industrial task. The programmable logic controller PLC controls the industrial task and thereby frequently employs the AI model that is executed on the Neural Processing Unit NPU or on another execution environment. For example, the PLC might supervise the “health status” of an electrical machine and periodically feeds status information (vibration data, temperature data, electrical parameters) to the AI model which returns with a health status information (o.k.; critical; defective).

In the example, the approach commences with a definition of an AI model compression rate rᵢ. The model compression rate rᵢ is defined as follows: having initial AI model M with a number of parameters n, a compressed AI model M* with a number of parameters n* is determined so that the compression rate r can be described by parameter r such that

$$\text{r} \left(\text{M,} \text{M*}\right) = \frac{n}{n *} .$$

If the initially chosen model M has 100 parameters and a compressed model M* with a compression rate of 2 can be found, then this means that after a model compression 50 parameters are obtained and therefore less computational effort and less memory space are required to run the compressed model.

The disclosed method consists of three stages (see FIG. 1). In stage 1, when little empirical data exists, operation research technique are applied to find the optimal rate. In stage 2, for which large amount of data in different tasks have been collected, a machine learning model is trained and subsequently (stage three) this machine learning model is used to obtain the optimal compression rate r*.

The algorithm and method steps of stage 1 are shown schematically in FIG. 2. The algorithm of stage 1 is a method to choose for an optimal compression rate r* of AI model with respect to analytical project requirements, maximizing AI model accuracy and can be described as follows:
Input of the method steps of stage 1:
Initially chosen trained model M with number of parameters n; set of compression rates S;
set of Analytical project deployment requirements R (memory allocation limit, inference time limit, etc.).

Output of the method steps of stage 1:

the optimal compression rate r* with respect to R, leading to the optimal compressed model M*.

A pseudocode of these steps can be sketched as:
1: for each rᵢ in S do:
2: compress model M by rate ri and obtain model mi
3: test (execute) compressed model mᵢ
4: record inference time ti and accuracy aᵢ of a model mᵢ
5: Define function h(ri)= rᵢ *n
6: Utilizing data of recorded (ti, aᵢ, rᵢ) :
   employ minimization of mean squared error to fit linear or non-linear functions of f, and g, such that
   ti = f (rᵢ) , and ai = g (rᵢ)
7: Define the optimization problem P as follow:
   maximize g(ri) (accuracy) subject to:
   f(rᵢ) < inference time requirement from R
   h(ri) < memory allocation requirement from R
8: if all g(rᵢ), f(rᵢ) are linear functions, solve P using linear programming, if any of g(ri), k(ri), f(ri) are non-linear functions, solve P utilizing non-linear programming, which returns the r*.
9: Compress M with optimal compression rate r*
10: Return compressed model M*, optimal compression rate r*

Accordingly, stage 1 of the inventive method consists of 4 major steps:

First: compression of an AI model with a set of different compression rates. At first, the compression occurs several times by different value of compression rate {r1, r2, ...} and these models are saved.

The different values might be determined (chosen) by dividing an overall range of compression range (e.g., 1.5 to 10) in a number (e.g., 10) of equidistant steps. A system engineer might input or change these parameters. However, in other embodiments the system itself may decide on the range and number of the compression rates for this step, e.g., having a lookup-table for these parameters in which for each kind (type) of an industrial task these parameters are proposed.

There are different algorithms to compress AI models (e.g., knowledge distillation, or weight quantization). Such compression is, inter alia, described in: A Survey of Model Compression and Acceleration for Deep Neural Networks; Yu Cheng, Duo Wang, Pan Zhou, Member, IEEE, and Tao Zhang, Senior Member, IEEE. It should be understood the compression algorithm utilize in accordance with the invention is chosen and fixed, so that each compression rate would only have one corresponding inference accuracy score.

Second: testing the performances of compressed models obtained at the step 1. At this step, the performance of every compressed model is tested, two test values are considered:
a) An AI model inference accuracy ai, which can be obtained right away on the testing dataset, and
b) An inference time tᵢ, which can be performed on edge itself, or on an edge simulator, or on another device with the comparable hardware characteristics.

Third: obtain the function of f(r), g(r) and h(r). Given the collected data (r1, t1, a1) ... (rₙ, tₙ, aₙ), we fit functions of inference time and inference accuracy:
tᵢ = f (rᵢ) ,
aᵢ = g (rᵢ)
with a usage of minimization of mean squared error. In the general case, f and g might be either a linear or non-linear function depending on datapoints (typically, f and g might be approximated by linear or exponential functions). The function of memory space is also defined: h(ri) = rᵢ * n. It is now possible to formulate the optimization problem P as the following:

Maximize g(r) with respect to:
f(r) < inference time limit requirement from R (“Requirements”), and
h(r) < memory allocation limit requirement from R, which is a typical linear/non-linear programming optimization problem that consists of an objective function and several inequality constraints. If f, g, h are all linear functions, it is a linear programming problem, if any of them are non-linear function, it will be non-linear programming problem. Such problems and their solution are known, see for example: Kantorovich, L. V. (1940). A new method of solving some classes of extremal problems. Doklady Akad Sci SSSR. 28: 211-214.

Fourth: solve the optimization problem P using linear (or non-linear) programming technique. Both linear/non-linear programming are well studied topics in operation research. There are several existing algorithms to solve the problem. For example, simplex method for linear programming; approximation programming, convex programming for non-linear programming. Finally, after solving P, the best compression rate r* is obtained for the AI model compression. Upon applying this optimal compression rate r*, an optimal compressed AI model is obtained for the deployment in a particular AI task under requirements R.

The above-described method can be generalized in the following way: performing analytical tasks with certain requirements and utilizing the method shown in FIG. 1 the information that can be stored in a database is obtained, which can be summarized like an example in the table showed in FIG. 3, which is the starting point for stage 2 of the method.

In the table, all the information about the AI task and deployment requirements is gathered together. In the beginning, the inventive method populates this table according to a workflow described in the stage 1 and outputs an optimal compression rate r*.

After being applied to N AI tasks, an additional machine learning model is trained (stage 2) using information from the table shown in FIG. 3. Having such a model allows the avoidance of running expensive algorithm described in Algorithm 1 every time, and can recommend an optimal compression rate r* for every new, but similar AI task with a usage of this machine learning model (stage 3).

Accordingly, the information of the table is fed into a machine learning model, e.g., neural network or the like. Once the machine learning model is trained, it can be employed for choosing an optimal compression rate r* for a new industrial task. This is done in a third stage (employment of the trained machine learning model), shown in the right-hand side box of FIG. 1.

A description (type of the problem, type or name of the customer, power class of a machine, material type of a part etc.) of the new task, a chosen compression algorithm, memory allocation of the uncompressed AI model and Requirements (inference time limit, memory space constraints) for the execution might be suitable inputs for the machine learning system.

The machine learning system responds by a value for a suitable, optimal compression rate r*. Finally, the new AI model is compressed according to that compression rate r* and used for fulfilling the new AI task, e.g., control of an industrial device or process or prediction/scheduling of maintenance tasks. The advantage is, that based on the similarity of the AI tasks and the requirements, an answer (value for an optimal compression rate r*) can be found without having at hand empirical data that matches with the new problem in an identical matter and without the obligation to do a new series of execution of the new AI task with different compression rates.

In an advantageous embodiment, other parameters can also be proposed with the trained machine learning model. For example, the best fitting compression algorithm (Weight quantization, Tensor decomposition, Knowledge Distillation, ...) can be proposed automatically for a new industrial task (“new AI task”) and its new AI model.

In an advantageous embodiment, the description of the AI task can be defined using a markup language. Such is ideal for automatic evaluation in training and, later, using the machine learning model.

In comparison to conventional methods, the method in accordance with the invention has better performance and efficiency. That is achieved because theoptimization is performed with respect to maximum inference time required, memory allocation limit required, and maximizing inference accuracy. After the generalization of the proposed workflow, it is possible to directly choose an optimal compression rate r* and to reduce the computational effort that is necessary in traditional methods when running an expensive iterative algorithm on edge devices ED or comparable hardware setup.

Conventional methods concentrate on tuning hyperparameters of a fixed compression algorithm in an expensive iterative manner until the requirements are met, regardless of a final inference accuracy. The method of the invention, in contrast, finds an optimal compression rate r* with respect to maximal inference accuracy and limited hardware resources in the stage 1, and with a stage 2 a generalization over the AI tasks and additional requirements as summarized in Table of FIG. 3 is performed. Utilizing this generalization (stage 3), running complex algorithms is thus avoided.

In the stage 1 of the inventive method, only a few numbers of trials on edge or comparable hardware setup (execution environments) are required to fit functions f and g, and linear/non-linear programming is applied afterward, which avoids the large number of iterative steps performed in conventional methodologies. In stages 2 and 3, after generalization of results from stage 1 performing these computations is no longer needed and an optimal compression rate r* with a usage of computational inexpensive machine learning algorithm is provided.

The method in accordance with the invention provide a way to improve the flexibility and efficiency of deploying trained AI models on different devices, e.g., Siemens′ S7-1500 TM NPU (technology module - neural processing unit) and Siemens’ Industrial Edge so that the method can be scaled to various verticals that work with promising edge technologies resulting in a cost advantage in comparison to other methods. The method of the invention moreover allows effective deployment of a highly accurate and computational efficient AI model for customer needs within a short time period.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-11. (canceled)

12. A method for determining a compression rate r* for an AI model of an industrial task (Task 1, ..., k; Task k+1, ..., k+n) according to a set of requirements for runtime properties of the AI model, an original number of parameters (n) being reduced to a reduced number of parameters (n*) for the AI model, the method comprising:
determining, in a first stage, a number of different compression rates rᵢ for the assigned AI model for a number of different AI models for a number of industrial tasks (Task 1, ..., k) for each of the industrial tasks (Task 1, ..., k), each AI model with that number of different compression rates rᵢ being compressed, the compressed AI models being executed in an execution environment, the runtime properties being recorded as first results during execution of each of the AI models, an analytical analysis of the first results being performed to calculate an optimal compression rate r* for each of the AI models, the optimal compression rate r* for each industrial task (Task 1, ..., k) together with a description of the industrial task being stored in a database;
utilizing, in a second stage, the data from the database to train an additional machine learning model, the additional machine learning model having feature information about each of the industrial tasks (Task 1, ..., k) as an input and the calculated optimal compression rate r* as an output, the feature information at least comprising information of memory allocation limit, inference time limit for the compressed model, an original AI model size of the uncompressed AI model, and a compression algorithm utilized; and
defining, in a third stage for a new AI model of a new task (Task k+1, ..., k+n), a new set of desired runtime properties and employing an additional machine learning model for determining an optimal compression rate r* for that new AI model with respect to desired runtime properties.

13. The method of claim 12, wherein during said compression of each AI model a compressed AI model is created for every compression rate r*.

14. The method of claim 12, wherein at least memory consumption and inference time of the executed AI model are utilized as runtime properties.

15. The method of claim 14, wherein an optimal compression rate r* is the compression rate r* with a best inference accuracy a which still fits requirements for the runtime properties during said analytical analysis of the first results.

16. The method of claim 12, wherein for each industrial task linear or non-linear functions are fitted through the recorded runtime properties during said analytical analysis of the first results.

17. The method of claim 16, wherein the function is an interpolation.

18. The method of claim 12, wherein an industrial edge device ED is utilized as the execution environment.

19. The method of claim 12, wherein the runtime properties of the uncompressed AI model and the requirements are stored together with the optimal compression rate r* during said analytical analysis of the first results.

20. The method of claim 12, wherein during said execution of the compressed AI models the execution environment is one of a Personal Computer, a real programmable logic controller PLC, an emulated programmable logic controller, a cloud computing service CCS, or an industrial edge device ED.

21. A system for determining a compression rate r* for an AI model of an industrial task (Task 1, ..., k; Task k+1, ..., k+n) according to a set of requirements for runtime properties of the AI model, an original number of parameters (n) being reduced to a reduced number of parameters (n*) for the AI model, the system comprising:
a first computer system (CS1) configured to:
determine, in a first stage, a number of different compression rates rᵢ for the assigned AI model for a number of different AI models for a number of industrial tasks (Task 1, ..., k) for each of the industrial tasks (Task 1, ..., k), each AI model with that number of different compression rates rᵢ being compressed, the compressed AI models being executed in an execution environment, the runtime properties being recorded as first results during execution of each of the AI models, an analytical analysis of the first results being performed to calculate an optimal compression rate r* for each of the AI models, the optimal compression rate r* for each industrial task (Task 1, ..., k) together with a description of the industrial task being stored in a database, the first computer system (CS1) being further configured to control the execution environment while execution of the compressed AI models occurs;
a second computer system (CS2) configured to:
utilize, in a second stage, the data from the database to train an additional machine learning model, the additional machine learning model having feature information about each of the industrial tasks (Task 1, ..., k) as an input and the calculated optimal compression rate r* as an output, the feature information at least comprising information of memory allocation limit, inference time limit for the compressed model, an original AI model size of the uncompressed AI model, and a compression algorithm utilized; and
define, in a third stage for a new AI model of a new task (Task k+1, ..., k+n), a new set of desired runtime properties and employing an additional machine learning model for determining an optimal compression rate r* for that new AI model with respect to desired runtime properties; and
a communication channel connecting the first and the second computer systems (CS1, CS2).

22. A non-transitory computer-readable program product, encoded with computer readable program code which, when executed by a processor on a computer, determines a compression rate r* for an AI model of an industrial task (Task 1, ..., k; Task k+1, ..., k+n) according to a set of requirements for runtime properties of the AI model, an original number of parameters (n) being reduced to a reduced number of parameters (n*) for the AI model, the computer readable program code comprising:
program code for determining, in a first stage, a number of different compression rates rᵢ for the assigned AI model for a number of different AI models for a number of industrial tasks (Task 1, ..., k) for each of the industrial tasks (Task 1, ..., k), each AI model with that number of different compression rates rᵢ being compressed, the compressed AI models being executed in an execution environment, the runtime properties being recorded as first results during execution of each of the AI models, an analytical analysis of the first results being performed to calculate an optimal compression rate r* for each of the AI models, the optimal compression rate r* for each industrial task (Task 1, ..., k) together with a description of the industrial task being stored in a database;
program code for utilizing, in a second stage, the data from the database to train an additional machine learning model, the additional machine learning model having feature information about each of the industrial tasks (Task 1, ..., k) as an input and the calculated optimal compression rate r* as an output, the feature information at least comprising information of memory allocation limit, inference time limit for the compressed model, an original AI model size of the uncompressed AI model, and a compression algorithm utilized; and
program code for defining, in a third stage for a new AI model of a new task (Task k+1, ..., k+n), a new set of desired runtime properties and employing an additional machine learning model for determining an optimal compression rate r* for that new AI model with respect to desired runtime properties.
